(19) United States
(12) Patent Application Publication
(10) Pub. No.: US 2009/0191726 A1
(43) Pub. Date: Jul. 30, 2009

(54) Connecting device and method for electronic machinery

(75) Inventors: Min Young Park, Suwon-si (KR); Se Young Jang, Yongin-si (KR); Gyun Heo, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/230,393

(22) Filed: Aug. 28, 2008

(30) Foreign Application Priority Data
Jan. 30, 2008 (KR) 10-2008-9384

(51) Int. Cl. H01R 12/00

(52) U.S. Cl. 439/65

(57) ABSTRACT

A connecting device and method for electronic machinery. The connecting device for electronic machinery includes a PCB provided with first contact points, a case provided with second contact points, on which electronic parts are mounted, and at least one connection member formed integrally with at least one of the PCB and the case such that the first and second contact points can be electrically connected. The connecting device for electronic machinery can electrically connect electronic parts having contact points easily without any additional part.

### CROSS-REFERENCE TO RELATED APPLICATIONS

This application claims the benefit of Korean Patent Application No. 10-2008-0009384, filed Jan. 30, 2008, in the Korean Intellectual Property Office, the disclosure of which is incorporated herein by reference.

### BACKGROUND

1. Field

Embodiments of the present invention relate to a connecting device and method for electronic machinery, and more particularly, to a connecting device for electronic machinery, which electrically connects electronic machines having contact points without requiring any additional parts.

2. Description of the Related Art

In general, electronic parts including various chips are mounted on a printed circuit board (PCB), and the PCB provided with a circuit implemented thereon is installed in a case, thus completing a product.

After a copper film is applied to a thin insulator substrate, a circuit wiring is printed on the substrate using a resist, and the substrate is dipped in an etching solution. The etching solution can melt copper, but cannot etch the circuit wiring printed using the resist. Accordingly, when etching is performed, only the circuit wiring printed using the resist remains, and thus a desired PCB is obtained.

Recently, as electronic machines have been developed to miniaturization and high quality trends, advancements in circuit integration have been rapidly increasing. Accordingly, a PCB provided with several layers of a printed circuit wiring, which are stacked, rather than a PCB provided with a single layer of a printed circuit wiring is used, thus maximizing space efficiency.

Further, circuit wirings and various electronic parts, which need to be implemented on a PCB, are implemented on the inner surface of a case, thus being capable of satisfying light-weight, thin-profile, short-length, and miniaturization trends of products.

Hereinafter, a conventional connecting device for electronic machinery will be concretely described, with reference to FIGS. 1 and 2.

A conventional connecting device 110 for electronic machinery includes a PCB 122 having first contact points 132, and a case 126 having second contact points 136.

A first circuit wiring 124 is provided on the PCB 122, and connects various electronic parts 125 mounted on the PCB 122, in order to transmit electric signals to the electronic parts 125. A second circuit wiring 128 is provided on the case 126, and is electrically connected to the first circuit wiring 124 by connection members 140 and second contact points 136.

The connection members 140,132 and 126 electrically connect the first circuit wiring 124 and the second circuit wiring 128 so that a circuit can be normally operated. The connection members include through holes 142 formed through the PCB 122, connection holes 144 formed on the case 126, screws 146 connecting the through holes 142 and the connection holes 144, and first and second connectors 132 and 126.

When the formation of the first and second circuit wirings 124 and 128 on the PCB 122 and the case 126 and the mounting of the required electronic parts 125 on the PCB 122 are completed, the first and second connectors 132 and 136 are connected, and the screws 146 are inserted into the through holes 142 and connected to the connection holes 144, thus mechanically fixing the PCB 122 to the case 126.

However, the conventional connecting device for electronic machinery requires additional parts, such as the screws for mechanical fixation and wires for electrical connection, so as to connect the contact points, and further requires an additional process for fixing these parts, thus complicating the manufacturing process and increasing manufacturing costs.

### SUMMARY

Therefore, one aspect of embodiments of the present invention is to provide a connecting device and method for electronic machinery, which electrically connects electronic machines having contact points easily without any additional part.

Additional aspects and/or advantages will be set forth in part in the description which follows and, in part, will be apparent from the description, or may be learned by practice of the invention.

In accordance with one aspect, embodiments of the present invention provide a connecting device for electronic machinery comprising a PCB provided with first contact points on which electronic parts are mounted; a case provided with second contact points; and at least one connection member formed integrally with at least one of the PCB and the case such that the first and second contact points can be electrically connected.

The at least one connection member may be formed on the case accommodating the PCB; and the at least one connection member may be at least one hook, which is protruded from the case so as to correspond to the outer perimeter surface of the PCB, and connects the PCB to the case.

A plurality of hooks, separated from each other, may be provided.

One hook may be provided along the outer perimeter surface.

Preferably, the hook includes an opening part providing a space for installing the second contacts.

The at least one hook may elastically support the PCB so as to prevent the movement of the PCB.

The PCB may be slidably connected to the case.

The hook may include a projecting part which extends from the case, a connecting part formed at the end of the projecting part and a supporting part connected to the end of the connecting part and directly contacts the PCB.

In accordance with another aspect of embodiments of the present invention, a method of connecting to a case, a PCB with contact points formed by a molded interconnect device technique is provided, the method including inserting the PCB into an end of the case, sliding the PCB through a space formed by at least one hook provided within the case, elastically deforming the at least one hook provided within the case, exerting an elastic force upon the upper surface of the PCB, by the at least one hook, and preventing movement of the PCB when contact points within the case are connected to the contact points of the PCB.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is an exploded perspective view of a conventional connecting device for electronic machinery;

FIG. 2 is an assembled perspective view of the connecting device for electronic machinery of FIG. 1;

FIG. 3 is a perspective view of a connecting device for electronic machinery in accordance with an embodiment of the present invention;

FIGS. 4 and 5 are cross-sectional views taken along the line A-A of FIG. 3;

FIG. 6 is a perspective view of a connecting device for electronic machinery in accordance with an embodiment of the present invention; and

FIG. 7 is a cross-sectional view taken along the line B-B of FIG. 6.

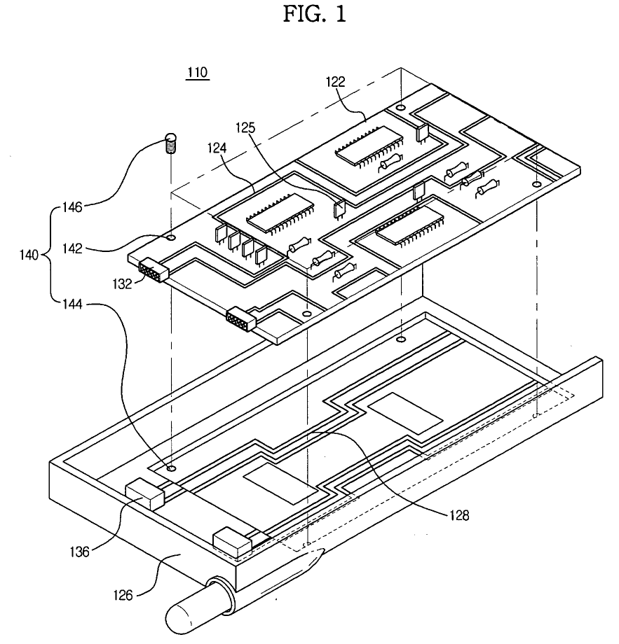

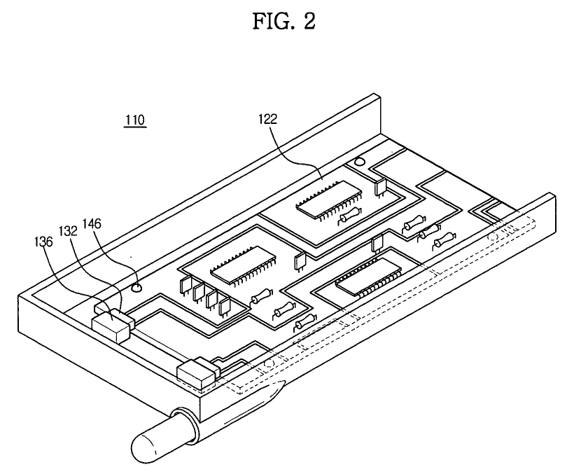

### DETAILED DESCRIPTION OF THE EMBODIMENTS

Reference will now be made in detail to the embodiments of the present invention, an example of which is illustrated in the accompanying drawings, wherein like reference numerals refer to like elements throughout. The embodiments are described below to explain the present invention by referring to the annexed drawings.

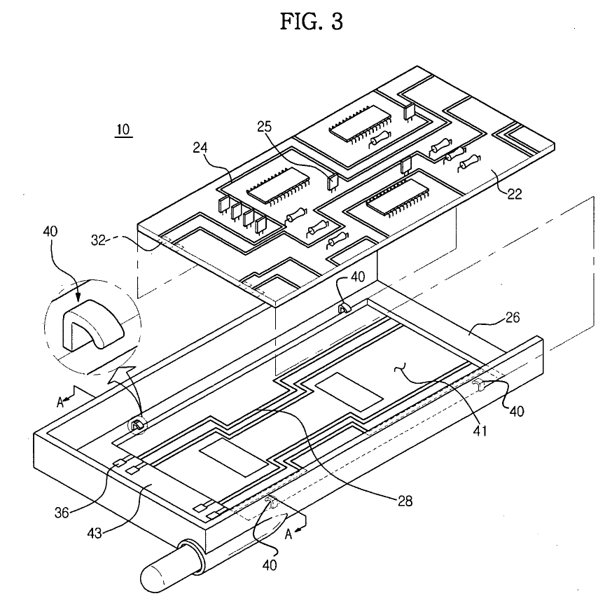

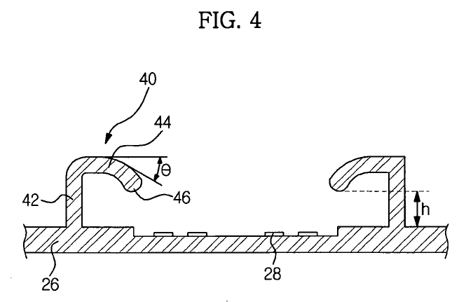

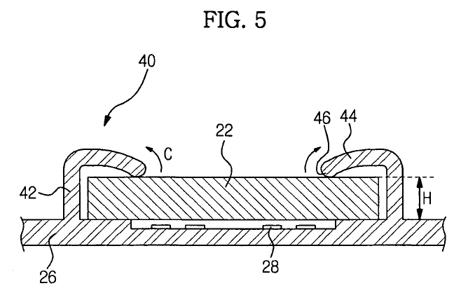

FIG. 3 is a perspective view of a connecting device for electronic machinery in accordance with an embodiment of the present invention, and FIGS. 4 and 5 are cross-sectional views taken along the line A-A of FIG. 3.

As shown in FIGS. 3 to 5, a connecting device 10 for electronic machinery in accordance with an embodiment may include contact points 32 and 36, respectively formed on electronic platforms, i.e., a PCB 22 and a case 26, and connection members, i.e., hooks 40 for electrically connecting the contact points 32 and 36.

The PCB 22 includes a first circuit wiring 24. The first circuit wiring 24 connects various electronic parts, for example 25, installed on the PCB 22, thus transmitting electric signals to the electronic parts, for example 25. In order to increase the integration of a circuit, a multi layer PCB may be used as the PCB 22. In addition to the first circuit wiring 24 of the PCB 22, a second circuit wiring 28 may be provided on the case 26.

The case 26 serves to protect various parts including the PCB 22 installed therein and increases the aesthetics of the device through finishing treatments, such as coloring or coating of the outer surface of the case 26. Further, the second circuit wiring 28 is provided on the inner surface of the case 26 so as to maximize space efficiency and reduce expenses when a multi layer PCB is used as the PCB 22.

The second circuit wiring 28 is provided on a depressed portion 41 of the case 26. Since the second circuit wiring 28 is provided on the depressed portion 41 of the case 26, the second circuit wiring 28 does not cause interference with the first circuit wiring 24 provided on the PCB 22. The first and second circuit wirings 24 and 28 respectively provided on the PCB 22 and the case 26 do not form separate circuits, but form a single circuit. In order to form the single circuit, the first and second circuit wirings 24 and 28 are electrically connected through the contact points 32 and 36.

The contact points 32 and 36 are connection portions for electrically connecting the first circuit wiring 24 provided on the PCB 22 and the second circuit wiring 28 provided on the case 26. The contact points 32 and 36 and the second circuit wiring 28 are formed by a molded interconnect device (MID) technique through laser processing or stamping. The contact points 32 and 36 may be respectively provided on the PCB 22 and the case 26, and after the assembly of the PCB 22 and the case 26 is completed, the contact points 32 and 36 contact each other such that they can be electrically connected. The contact points 32 and 36 are divided into first contact points 32 provided on the PCB 22 and second contact points 36 provided on the case 26.

The first contact points 32 are provided on the rear surface of the PCB 22. That is, the first contact points 32 are provided on the surface of the platy PCB 22, that is adjacent to the case 26. The second contact points 36 are provided on the case 26 deviating from the depressed portion 41. That is, the second contact points 36 are provided on a prominent portion 43. Accordingly, even if the assembly of the PCB 22 and the case 26 is complete, the second circuit wiring 28 does not contact the PCB 22, but the first contact points 32 and the second contact points 36 contact each other and thus are electrically connected. The first and second contact points 32 and 36 contact each other by the hooks 40 and the electrically connecting state therebetween is maintained.

The hooks 40 may be provided on the case 26 so as to electrically connect the first and second contact points 32 and 36. The hooks 40 may be provided on the case 26 so as to correspond to the outer perimeter surface of the platy PCB 22, and thus support the PCB 22 at four points. That is, four hooks 40 may be provided such that two hooks 40 support each of the two opposite sides of the PCB 22. When the PCB 22 is connected to the case 26, the hooks 40 are elastically deformed. The elastically deformed hooks 40 pressurize the upper surface of the PCB 22, and thus cause the PCB 22 to be closely adhered to the case 26. Thereby, the first contact points 32 of the PCB 22 and the second contact points 36 of the case 26 contact each other such that they can be electrically connected, and the PCB 22 cannot be easily moved by external force. In the case that the hooks 40 may be provided at locations where the second contact points 36 need to be provided, it may be impossible to form the second contact points 36 through laser processing or stamping. Thus, the hooks 40 may be provided at locations not overlapping with the locations of the second contact points 36. As shown in FIGS. 4 and 5, each of the hooks 40 may include a projecting part 42, a connecting part 44, and a supporting part 46.

Referring now to FIGS. 3, 4 and 5, the projecting part 42 may be extended from the case 26. The projecting part 42 has a height higher than the height (H) of the PCB 22. Since the projecting part 42 has a height at least higher than the height (H) of the PCB 22, a space, in which the PCB 22 can be slidably connected to the hook 40, may be provided. The connecting part 44 is formed at the end of the projecting part 42.

The connecting part 44 is bent to the inside of the case 26, to which the PCB 22 is connected, and the supporting part 46 is a part, which is connected to the end of the connecting part 44 and directly contacts the PCB 22. The connecting part 44 may be bent such that it is tilted at a designated angle (θ) toward the case 26. Since the connecting part 44 is tilted at the designated angle (θ), the height (h) of the end of the supporting part 46 substantially contacting the PCB 22 is lower than the height (H) of the PCB 22. When the PCB 22 slides in and is connected to the hooks 40 by interference fit, the connecting parts 44 of the hooks 40 are elastically deformed in the outward direction (C), and the stored elastic force acts on a force for causing the supporting parts 46 to pressurize the upper surface of the PCB 22. Thus, the PCB 22 is closely adhered to the case 26, thus preventing the movement of the PCB 22 and facilitating the electrical connection between the first and second contact points 32 and 36.

Hereinafter, the operation of the above-mentioned connecting device for electronic machinery in accordance with an embodiment will be described.

The PCB 22 may come close to the case 26 from the side such that the PCB 22 can be slidably connected to the inside of a space formed among the hooks 40, two of which are formed at each of opposite two sides of the case 26. When the PCB 22 becomes close to the hooks 40 and contacts the side surfaces of the hooks 40, the PCB 22 having the height (H) larger than the height (h) of the ends of the supporting parts 46 elastically deforms the supporting parts 46 in the outward direction (C).

Then, the PCB 22 slides continuously such that the first contact points 32 provided on the PCB 22 and the second contact points 36 provided on the case 26 contact. When external force sliding the PCB 22 is removed after the first and second contact points 32 and 36 contact, only the elastic force pressurizing the upper surface of the PCB 22 may remain due to a difference between the height (h) of the ends of the supporting parts 46 and the height (H) of the PCB. Thus, the PCB 22 is closely adhered to the case 26 and does not move. Consequently, the first and second contact points 32 and 36 are electrically connected. That is, the mechanical connection between the PCB 22 and the case 26 and the electrical connection between the PCB 22 and the case 26 are concurrently achieved only by connecting the PCB 22 to the hooks 40 without mechanically connecting the PCB 22 to the case 26 and then electrically connecting the PCB 22 to the case 26 using any separate connection member or through a connecting process.

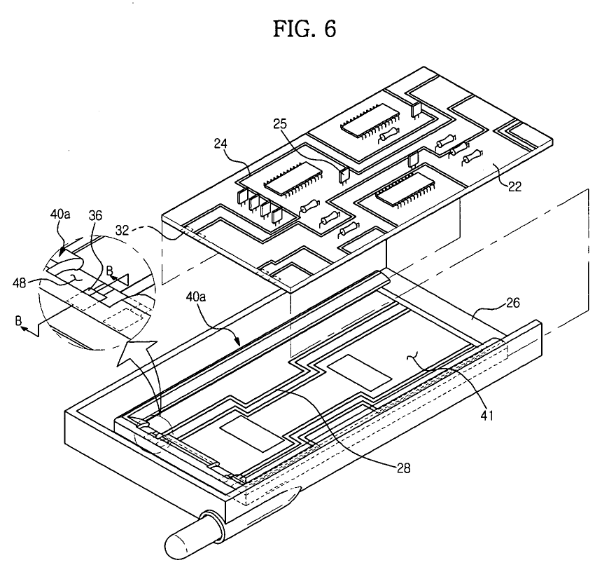

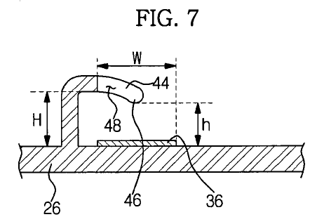

FIGS. 6 and 7 illustrate a connecting device for electronic machinery in accordance with an embodiment of the present invention. Some parts in this embodiment may be substantially the same as those in the embodiment exemplified in FIGS. 3, 4 and 5, and thus denoted by the same reference numerals even though they are depicted in different drawings. Further, a part of the construction and operation of the embodiment shown in FIGS. 6 and 7 are substantially the same as those of other embodiment and a detailed description thereof will thus be omitted because it is considered to be unnecessary. Parts in this embodiment, which are modified from the other embodiment, are denoted by reference numerals with a suffix ‘a’.

FIG. 6 is a perspective view of the connecting device for electronic machinery in accordance with another embodiment of the present invention, and FIG. 7 is a cross-sectional view taken along the line B-B of FIG. 6.

As shown in FIGS. 6 and 7, a connecting device for electronic machinery in accordance with another embodiment includes one hook 40a provided on the case 26 so as to correspond to the outer perimeter surface of the PCB 22.

The connecting device for electronic machinery of the embodiment exemplified in FIGS. 6 and 7 differs from that of other embodiments in that one long hook, or a hook-like rail, 40a may be provided. Since the hook 40a spans or surrounds three sides of the PCB 22, the elastic force of the supporting part 46 of the hook 40a highly acts upon the PCB 22. Thus, the contact between the first and second contact points 32 and 36 may be more firmly achieved. An opening part 48 is provided on the hook 40a.

The opening part 48 is provided at an overlap area, where the hook 40a would have been overlapped with the second contact points 36. The second contact points 36 are provided through laser processing or stamping, and a working space (W) above the surfaces of the second contact points 36 is required so as to form the second contact points 36 with a tool for laser processing or stamping. In order to provide the working space (W), the opening part 48 is obtained by partially cutting the connecting part 44 of the hook 40a.

Although the above-mentioned embodiments describe that hooks are used as connecting members, the connecting members are not limited to the hooks so far as the PCB can be connected to the case.

Further, although the above-mentioned embodiments describe that the hooks pressurize the upper surface of the PCB, the hooks are not limited thereto, so far as the contact between the contact points can be secured.

Further, although the above-mentioned embodiments describe that the connecting members are provided on the case, the connecting members may be provided on the PCB or both the PCB and the case such that they can correspond to each other.

Further, although the above-mentioned embodiments describe that the PCB is slidably connected to the case, embodiments of the present invention are not limited to the PCB being connected slidably.

As apparent from the above description, embodiments of the present invention provide a connecting device for electronic machinery, which easily electrically connects electronic machines having contact points without requiring any additional parts.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A connecting device for electronic machinery comprising:
a PCB provided with first contact points, on which electronic parts are mounted;
a case provided with second contact points; and
at least one connection member formed integrally with at least one of the PCB and the case such that the first and second contact points are electrically connected.

2. The connecting device according to claim 1, wherein:
the at least one connection member is formed on the case accommodating the PCB;

3. The connecting device according to claim 2, wherein
the at least one connection member is at least one hook.

4. The connecting device according to claim 3, wherein the at least one hook is protruded from the case so as to correspond to the outer perimeter of the surface of the PCB, and connects the PCB to the case.

5. The connecting device according to claim 4, wherein the at least one hook is a plurality of hooks, separated from one another.

6. The connecting device according to claim 2, wherein the at least one connection member is one hook provided along the outer perimeter surface of the case.

7. The connecting device according to claim 6, wherein the hook includes an opening part providing a space for installing the second contact points.

8. The connecting device according to claim 3, wherein the at least one hook elastically supports the PCB so as to prevent movement of the PCB.

9. The connecting device according to claim 4, wherein the at least one hook elastically supports the PCB so as to prevent movement of the PCB.

10. The connecting device according to claim 5, wherein the at least one hook elastically supports the PCB so as to prevent movement of the PCB.

11. The connecting device according to claim 6, wherein the at least one hook elastically supports the PCB so as to prevent movement of the PCB.

12. The connecting device according to claim 7, wherein the at least one hook is a hook-like rail spanning three sides of the PCB.

13. The connecting device according to claim 2, wherein the PCB is slidably connected to the case.

14. The connecting device according to claim 3, wherein each of the at least one hook comprise:
a projecting part which extends from the case;
a connecting part formed at the end of the projecting part;
a supporting part connected to the end of the connecting part and directly contacting the PCB.

15. The connecting device according to claim 14, wherein the connecting part is bent such that it is tilted at a designated angle toward the case.

16. The connecting device according to claim 15, wherein the supporting part exerts an elastic force upon the upper surface of the PCB.

17. A method of connecting to a case, a PCB with contact points formed by a molded interconnect device technique, the method comprising:
inserting the PCB into an end of the case;
sliding the PCB through a space formed by at least one hook provided within the case;
elastically deforming the at least one hook provided within the case;
exerting an elastic force upon the upper surface of the PCB, by the at least one hook; and
preventing movement of the PCB when contact points within the case are connected to the contact points of the PCB.

18. The method according to claim 17 wherein at least one hook is a hook-like rail spanning three sides of the PCB.

19. The method according to claim 18 wherein the hook includes an opening part providing a space for installing the contact points where the PCB contacts the case.
